(19) United States
(12) Patent Application Publication
(10) Pub. No.: US 2016/0100199 A1
(43) Pub. Date: Apr. 7, 2016

(54) SYSTEM AND METHOD FOR CONTROLLING HOTEL CPE VIA PERSONAL SMART DEVICE

(71) Applicant: CHARTER COMMUNICATIONS OPERATING, LLC, St. Louis, MO (US)

(72) Inventor: Kreig DuBose, Portland, OR (US)

(73) Assignee: CHARTER COMMUNICATIONS OPERATING, LLC, St. Louis, MO (US)

(21) Appl. No.: 14/503,478

(22) Filed: Oct. 1, 2014

(51) Int. Cl. H04N 21/214; H04N 21/258

(52) U.S. Cl. CPC H04N 21/2143; H04N 21/25816; H04N 21/25875

(57) ABSTRACT

Systems, methods and apparatus enabling businesses or bulk customers (e.g., hotels) spanning geographic footprints of one or more MSOs to provide television, data and/or other services to each guest from the respective MSO associated with that guest, and in accordance with the personal settings, content settings and/or other MSO subscription parameters.

### FIELD OF THE INVENTION

The invention relates to controlling third-party customer premises equipment (CPE) using a personal communications device and, more particularly but not exclusively, to authenticating the third-party CPE to a multiple-systems operator (MSO) using a personal communications device such as a smart phone.

### BACKGROUND

Presently, hotel guests and the like use consumer premises equipment (CPE) such as set-top boxes and the like to receive television, data and/or other services at a hotel. Typically, the channel lineup, on-screen programming guide, content settings and the like of the hotel-delivered services are different than those experienced by the guest while at home. Further, enhanced services, custom settings and so on used by the guest at home may not be available to the guest at the hotel.

### SUMMARY

Various deficiencies in the prior art are addressed by systems, methods, apparatus and other mechanisms enabling businesses or bulk customers (e.g., hotels) spanning geographic footprints of one or more MSOs to provide television, data and/or other services to each guest from the respective MSO associated with that guest, and in accordance with the personal settings, content settings and so on associated with respective MSO subscription parameters.

In various embodiments, bidirectional communication between in-room CPE and a guest's mobile device is used to authenticate the CPE for MSO services access via a mobile device and/or guest against an available authentication service or agent. Once authentication is established, guest and/or guest device information is routed to the appropriate MSO system where settings and entitlements are exchanged and sent to the in-room CPE. Then, the in-room CPE may be controlled to reflect the personalized settings (e.g., user interface customizations, favorite channels, parental controls and the like) and programming options (e.g., premium channels, video-on-demand options, remote digital video recorder access and the like) available to the guest as if the guest was utilizing MSO services from home. In various embodiments the in-room CPE may be controlled via the guest mobile device. In various embodiments the in-room CPE is controlled via a local remote control device.

### BRIEF DESCRIPTION OF THE DRAWING

The teachings of the present invention can be readily understood by considering the following detailed description in conjunction with the accompanying drawing, in which:

FIG. 1 depicts a block diagram of a system according to one embodiment;

FIG. 2 depicts a flow diagram of a method according to one embodiment; and

FIG. 3 depicts a block diagram of a computing device suitable for use in performing the functions described herein.

To facilitate understanding, identical reference numerals have been used, where possible, to designate identical elements that are common to the figures.

### DESCRIPTION

The invention will be primarily described within the context of systems, methods, apparatus and other mechanisms providing television, data and/or other services to a guest at a hotel or other location from the specific service provider to which that guest normally subscribes. That is, a guest at a hotel having a home subscription to a particular cable television provider may interact with CPE at the hotel to be authenticated as a subscriber to that cable television provider and to receive services via the CPE from that cable television provider.

Various embodiments will be described within the context of a business or bulk customer such as a hotel associated with the geographic footprints of one or more MSOs to provide television, data and/or other services to each guest from the respective MSO associated with that guest, and in accordance with the personal settings, content settings and so on associated with respective MSO subscription parameters. Various embodiments also contemplate indirect connection of a guest to a respective MSO using, illustratively, an internal or corporate network associated with the business or bulk customer.

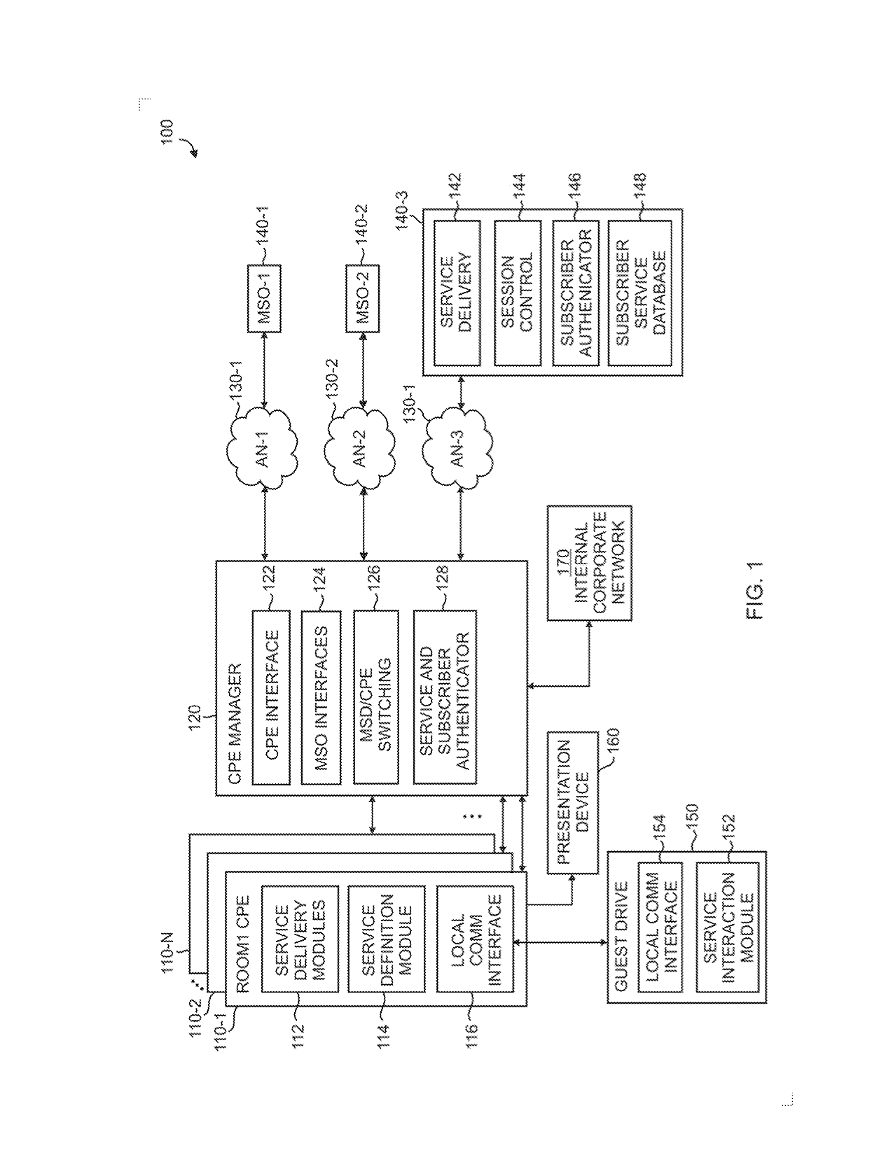

FIG. 1 graphically depicts a system according to one embodiment. Specifically, FIG. 1 depicts a system 100 wherein a hotel or other location selectively delivers to guests or users television, data and/or other services from one of a plurality of available service providers. For example, a hotel having a plurality of rooms may provide each room with a Set Top Box (STB) or television having interactive service capabilities for the benefit of hotel guests.

Referring to FIG. 1, each of a plurality of Customer Premises Equipment (CPE) denoted as 110-1, 110-2 and so on up to 110-N (collectively CPE 110) is configured to provide television, data and/or other services to a guest via a respective presentation device 160. Each CPE 110 is capable of communicating with a guest device 150 such as a smart phone, tablet computer, laptop computer or other guest device via a local communications interface. Each CPE 110 communicates with a CPE manager 120, which is configured to communicate with various service providers and support corresponding service delivery to the CPE 110. As an example, each room within the hotel may have located therein respective CPE (e.g., a set top box or STB) for delivering television services and the like to a display device (e.g., a television or other display device) for the benefit of the hotel guest.

Various embodiments operate to authenticate the CPE 110, the corresponding guest device 150 in communication with the CPE 110, and/or the user of the guest device to retrieve personalized MSO interaction and content settings for use by the in-room CPE in providing television, data and/or other services to the guest from the MSO.

The CPE manager 120 communicates with the CPE 110 and with each of a plurality of Multiple-System Operators (MSOs) such as cable television providers, satellite television providers and/or other service providers.

The CPE manager 120 determines, for each CPE 110, the appropriate service provider to be used for providing services to the CPE. This determination may be made with or without information associated with a guest. For example, in the absence of any information pertaining to the service provider associated with a guest, a default service provider may be selected to provide services to the CPE associated with that guest. However, if a guest indicates that he or she is a subscriber to the services associated with a particular service provider, then the CPE manager 120 supports authentication of that guest to that service provider and, if authenticated, delivery of services from that service provider to that guest.

The CPEs 110 are depicted as comprising a number of subsystems, including one or more service delivery modules 112, a service definition module 114 and a local communications interface 116.

The one or more service delivery modules 112 operate to deliver television, data and/or other services to a guest via, illustratively, a presentation device 160, a guest device 150 or some other device.

The service definition module 114 operates to define the types of services to which the guest is authorized, the service provider to which the guest is a subscriber and/or other information useful in defining or limiting service access by a guest. The functions of the service definition module 114 may be performed entirely at the CPE 110 or shared in whole or in part with the CPE manager 120.

The local communications interface 116 provides a mechanism for communicating with a guest device 150, such as by providing a Wireless Access Point (WAP) or other wireless communications channel.

The guest device 150 is depicted as comprising a number of subsystems, including a local communications interface 154 and a service interaction module 152. The local communications interface 154 is configured to support communications with the CPE 110 via the local communications interface 116. The service interaction module 152 is configured to support various session management and service functions between the guest device 150 and the appropriate MSO 140, as well as optional interface functions between the guest device 150 and hotel equipment (CPE 110 and CPE manager 120). In various embodiments, the service interaction module 152 comprises a website accessible to the guest device 150, a mobile device application executed at the guest device 150 or some combination thereof.

The CPE manager 120 communicates with each of the CPEs 110 as well as a plurality of service providers, illustratively, a first MSO 140-1, a second MSO 140-2 and a third MSO 140-3 (collectively MSOs 140). More or fewer MSOs 140 are supported within the context of the various embodiments. As depicted, the CPE 120 communicates with each of the MSOs 140 via a respective access network (AN) 130, such as a cable television network, a telecommunications network and so on.

The CPE manager 120 is depicted as comprising a number of subsystems, including CPE interface 122, MSO interfaces 124, MSO/CPE switching module 126 and service/subscriber authenticator 128.

The CPE interface 122 supports communications between the CPE manager 120 and the CPEs 110. Such communications may be provided by in-band or out-of-band channels within a hybrid fiber coaxial system, network distribution system and the like within the hotel or other location.

The MSO interfaces 124 support communications between the CPE manager 120 and the various MSOs 140. The MSO interfaces 124 and CPE interface 120 may be combined as a single interface depending upon the various technologies used to support communications with the CPE manager 120, the type of access networks 130 and other factors known to those skilled in the art.

The MSO/CPE switching module 126 operates to connect each CPE 110 with an access network 130 appropriate to an MSO 140. For example, if a hotel guest interacting with CPE 110-1 is a home subscriber to service provider 140-3, then the MSO/CPE switching module 126 will enable communications between CPE 110-1 and access network 130-3. In some embodiments, communications between CPE 110 and MSO 140 are direct such that selection and delivery of services provided by MSO 140 may be controlled by a guest device 150 interacting with the CPE 110. In some embodiments, communications between the CPE 110 and MSO 140 are subjected to processing by the CPE manager 120 to provide further control and customization of such services. In some embodiments, the MSO/CPE switching module 126 provides a physical layer switching fabric for connecting the CPEs 110 and ANs 130. In some embodiments, the MSO/CPE switching module 126 provides a logical switching fabric such as for routing packets between the various CPEs 110 and ANs 130.

The service/subscriber authenticator 128 supports at least an initial session management interaction between the CPE manager 120 and MSOs 140 sufficient to determine whether or not a guest device 150 is associated with an authorized MSO subscriber. If the guest device 150 provides information sufficient to authenticate subscriber status then the service/subscriber authenticator 128 will enable additional session interaction including services delivery to the CPE 110 associated with the subscriber, such as by coupling the CPE 110 and MSO 140 together via the MSO/CPE switching module 126. Otherwise additional session services will not be enabled.

The MSOs 140 are depicted as comprising a number of subsystems, including a service delivery module 142, a session control module 144, a subscriber authenticator module 146 and a subscriber service database 148.

The specific subsystems and other functional elements (not shown) of MSOs 140 are known to those skilled in the art. For purposes of this discussion it will be assumed that the service delivery module 142 is configured to provide various services to authenticated users via, illustratively, CPE 110. The session control module 144 is configured to establish, modify and/or tear down subscriber sessions such as sessions used to deliver television programming, data services and the like via service delivery module 142. The subscriber authenticator 146, whether implemented as a standalone module as depicted or included within the session controller 144, operates to determine whether or not a particular subscriber is authenticated with the MSO 140 and, if authenticated, the types of services to which the subscriber is entitled. The subscriber service database 148 is used to store subscriber information such as subscriber service level, service level agreement (SLA) requirements, authorized services so on.

In various embodiments, bidirectional communication between in-room CPE and a guest's mobile device is used to authenticate a mobile device and/or guest against an available authentication service or agent. Once authentication is established, guest and/or guest device information is routed to the appropriate MSO system where settings and entitlements are exchanged and sent to the in-room CPE. Then, the in-room CPE may be controlled to reflect the personalized settings (e.g., user interface customizations, favorite channels, parental controls and the like) and programming options (e.g., premium channels, video-on-demand options, remote digital video recorder access and the like) available to the guest as if the guest was utilizing MSO services from home. In various embodiments the in-room CPE may be controlled via the guest mobile device. In various embodiments the in-room CPE is controlled via a local remote control device.

In one embodiment, it is contemplated that the business or bulk customer comprises a hotel chain or other corporate entity having multiple locations in different geographic areas, where various locations are associated with various MSOs. In this embodiment, indirectly connecting CPE 110 and MSO 140 may comprise routing signal and/or packets between corporate locations to enable a guest at a first location not served by the guest's MSO to access the guest's MSO via a second corporate location that is served by the guest's MSO. Thus, in this embodiment, an internal corporate network 170 is accessed by the CPE manager 120 to provide such indirect routing of packets between guest room CPE 110 and the guest's MSO 140.

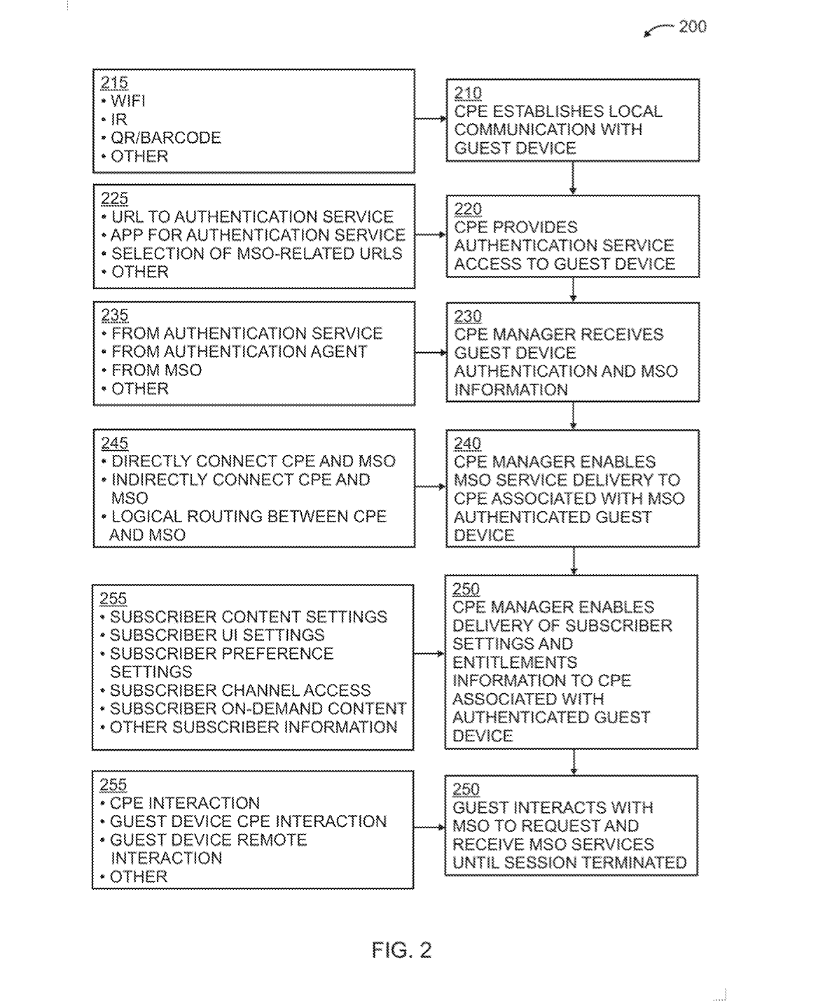

FIG. 2 depicts a flow diagram of a method according to one embodiment. Specifically, FIG. 2 depicts a flow diagram of interactions between various modules, functional elements, interfaces or portions thereof as described herein with respect to the various figures.

At step 210, a CPE 110 establishes local communication with guest device 150 (e.g., a hotel room guest uses his or her smart phone, tablet, laptop computer or other mobile device to establish communication with a hotel room set top box). Referring to box 215, the communication channel may comprise a Wi-Fi channel (e.g., 802.11x, WiMAX and the like), infrared (IR) and the like. In various embodiments, a quick response (QR) code, barcode and the like may be displayed on presentation device 160 by the CPE 110 which, when scanned by the guest device 150, enables the guest device 150 to communicate with the CPE 110 via a 3G/4G telecom network.

At step 220, the CPE 110 provides authentication service access to the guest device. That is, at step 220 the CPE 110 provides information to the guest device 150 sufficient to enable a guest device to interact with an authentication agent or authentication service. Referring to box 225, this information may comprise a Uniform Resource Locator (URL) pointing to an authentication service or agent, a mobile device application associated with an authentication service or agent, a selection of MSO-pointing URLs or some other mechanism.

At step 230, the CPE manager 120 receives guest device authentication and MSO information pertaining to the MSO subscription authenticated with respect to the mobile device. Referring to box 235, this information may be received from a authentication service, authentication agent, the MSO itself or some other source.

At step 240, the CPE manager 120 enables MSO service delivery to the CPE 110 associated with the guest device 150 associated with a subscription authenticated to the MSO 140. Referring to box 245, the CPE manager 120 may enable MSO service by directly or indirectly connecting the CPE 110 and MSO 140, via logical routing of traffic between the CPE 110 and MSO 140 or by some other means. For example, the CPE manager 120 may cause the MSO/CPE switching module to directly connect RF or network physical layer links between the CPE 110 and access network 130 associated with the MSO 140. The CPE manager 120 may also indirectly connect these elements by translating and propagating signals therebetween. The CPE manager 120 may also perform a routing function to forward packets/traffic between the CPE and MSO. Such a routing may be performed locally through the CPE manager 120 or remotely using the internal corporate network 170 (e.g., such as between the local hotel and a remote hotel within the same hotel chain).

At step 250, the CPE manager 120 enables delivery of subscriber settings and entitlements information to the CPE 110 associated with the authenticated guest device 150. Referring to box 255, such information may comprise subscriber content settings, subscriber user interface settings, subscriber preference settings, subscriber channel access or parental control settings, subscriber on-demand content or remote Digital Video Recorder (DVR) content, as well as other subscriber information or services.

At step 260, a guest interacts with a respective MSO to which he or she is authenticated to request therefrom and receive MSO services until such time as the session is terminated. Referring to box 265, such guest interaction may be supported by the guest interacting directly with the CPE 110 (e.g., front panel controls or CPE remote control device), interacting via the guest device 150, interacting via a remote interaction mechanism (e.g., a guest device application communicating with the CPE via a telecommunications network or other channel), or via some other interaction mechanism.

Generally speaking, the various embodiments described herein provide a mechanism enabling businesses or bulk customers (e.g., hotels) spanning geographic footprints of one or more MSOs to provide television, data and/or other services to each guest from the respective MSO associated with that guest, and in accordance with the personal settings, content settings and so on associated with respective MSO subscription parameters.

In various embodiments, bidirectional communication between in-room CPE and a guest's mobile device is used to authenticate a mobile device and/or guest against an available authentication service or agent. Once authentication is established, guest and/or guest device information is routed to the appropriate MSO system where settings and entitlements are exchanged and sent to the in-room CPE. Then, the in-room CPE may be controlled to reflect the personalized settings (e.g., user interface customizations, favorite channels, parental controls and the like) and programming options (e.g., premium channels, video-on-demand options, remote digital video recorder access and the like) available to the guest as if the guest was utilizing MSO services from home.

In various embodiments the in-room CPE may be controlled via the guest mobile device. In various embodiments the in-room CPE is controlled via a local remote control device.

Generally speaking, the various embodiments provide a mechanism by which a hotel guest may enjoy television, data and/or other services in a manner similar to that enjoyed by the guest at home.

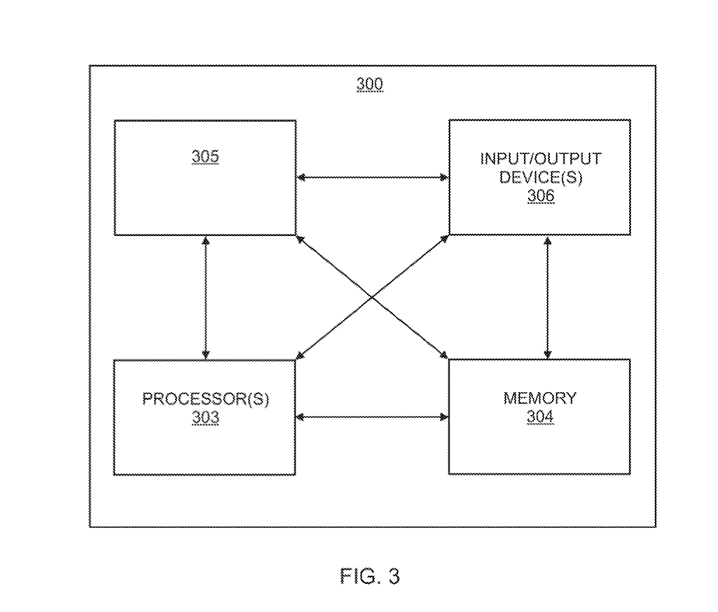

FIG. 3 depicts a block diagram of a computing device suitable for use in implementing various functional elements as described herein with respect to the figures. In particular, the computing device 300 of FIG. 3 is suitable for use in implementing various modules, functional elements, interfaces or portions thereof of the CPE 110, CPE manager 120, MSO 140, guest device 150 and/or other modules, functional elements or portions thereof described herein with respect to the various figures.

As depicted in FIG. 3, computing device 300 includes a processor element 303 (e.g., a central processing unit (CPU) and/or other suitable processor(s)), a memory 304 (e.g., random access memory (RAM), read only memory (ROM), and the like), a cooperating module/processor 305, and various input/output devices 306 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

It will be appreciated that the functions depicted and described herein may be implemented in hardware and/or in a combination of software and hardware, e.g., using a general purpose computer, one or more application specific integrated circuits (ASIC), and/or any other hardware equivalents. In one embodiment, the cooperating process 305 can be loaded into memory 304 and executed by processor 303 to implement the functions as discussed herein. Thus, cooperating process 305 (including associated data structures) can be stored on a computer readable storage medium, e.g., RAM memory, magnetic or optical drive or diskette, and the like.

It will be appreciated that computing device 300 depicted in FIG. 3 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product comprising a non-transitory computer readable medium storing instructions for causing a processor to implement the methods and/or techniques described herein are invoked or otherwise provided. Instructions for invoking the inventive methods may be stored in tangible and non-transitory computer readable medium such as fixed or removable media or memory, and/or stored within a memory within a computing device operating according to the instructions.

In at least some embodiments, an apparatus includes a processor and a memory communicatively connected to the processor. The processor is configured to support customer premises equipment (CPE) in communication with a guest device, the processor transmitting toward the guest device access information associated with an authentication service configured to authenticate the guest device to a multiple-systems operator (MSO); and in response to the guest device being authenticated to the MSO, providing MSO services via the CPE in accordance with subscriber settings and entitlement information received from the MSO.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method, comprising:
by customer premises equipment (CPE) in communication with a guest device, transmitting toward said guest device access information associated with an authentication service configured to authenticate the guest device to a multiple-systems operator (MSO);
in response to said guest device being authenticated to said MSO, providing MSO services via said CPE in accordance with subscriber settings and entitlement information received from said MSO.

2. The method of claim 1, wherein said CPE and said guest device are in wireless communication with each other.

3. The method of claim 1, wherein said guest device access information comprises a uniform resource locator (URL) pointing to an authentication service.

4. The method of claim 1, wherein said guest device access information comprises a plurality of URLs pointing to respective MSOs.

5. The method of claim 1, wherein said guest device access information comprises an authentication service application.

6. The method of claim 1, wherein providing MSO services via said CPE includes providing a user interface (UI) in accordance with subscriber UI settings.

7. The method of claim 1, wherein providing MSO services via said CPE includes providing content in accordance with subscriber content settings.

8. The method of claim 7, wherein providing MSO services via said CPE includes providing remotely stored content or on-demand content.

9. The method of claim 1, further comprising supporting subscriber interaction indicative of MSO service requests.

10. The method of claim 9, wherein said subscriber interaction is received via a CPE remote control device or said mobile device.

11. The method of claim 1, wherein providing MSO services via said CPE comprises selectively coupling said CPE to an access network associated with said MSO.

12. The method of claim 11, wherein said CPE is physically coupled to said access network via a radiofrequency (RF) signal path.

13. The method of claim 11, wherein said CPE is logically coupled to said access network via a packet routing mechanism.

14. The method of claim 13, wherein said CPE is at a first location and said access network is at a second location, said CPE and said access network being logically coupled together via an intermediate network between the first and second locations.

15. Apparatus including a processor and a memory communicatively connected to the processor, the processor configured to:
transmit, toward a guest device, access information associated with an authentication service configured to authenticate the guest device to a multiple-systems operator (MSO); and
in response to the guest device being authenticated to the MSO, provide MSO services via the CPE in accordance with subscriber settings and entitlement information received from the MSO.

16. The apparatus of claim 15, wherein said processor and memory communicatively connected to the processor are included within customer premises equipment (CPE) in wireless communication with the guest device.

17. The apparatus of claim 16, wherein said CPE is in communication with a CPE manager operative to authenticate the guest device to one or a plurality of available MSOs.

18. The apparatus of claim 15, wherein providing MSO services includes providing at least one of a user interface (UI) in accordance with subscriber UI settings, and content in accordance with subscriber content settings.

19. A computer program product comprising a non-transitory computer readable medium storing instructions for causing a processor to:
transmit, toward a guest device, access information associated with an authentication service configured to authenticate the guest device to a multiple-systems operator (MSO); and
in response to the guest device being authenticated to the MSO, provide MSO services via the CPE in accordance with subscriber settings and entitlement information received from the MSO.

20. A non-transitory computer readable medium storing instructions for causing a processor to:
transmit, toward a guest device, access information associated with an authentication service configured to authenticate the guest device to a multiple-systems operator (MSO); and
in response to the guest device being authenticated to the MSO, provide MSO services via the CPE in accordance with subscriber settings and entitlement information received from the MSO.
